(19) United States
(12) Patent Application Publication
(10) Pub. No.: US 2024/0176986 A1
(43) Pub. Date: May 30, 2024

(54) MULTI-OBJECTIVE NEURAL ARCHITECTURE SEARCH FRAMEWORK

(71) Applicant: Samsung Electronics Co., Ltd., Gyeonggi-do (KR)

(72) Inventors: Mostafa EL-KHAMY, San Diego, CA (US); Minsu CHO, New York, NY (US); Kee-Bong SONG, San Diego, CA (US)

(21) Appl. No.: 18/114,658

(22) Filed: Feb. 27, 2023

Related U.S. Application Data
(60) Provisional application No. 63/428,631, filed on Nov. 29, 2022.

(51) Int. Cl. G06N 3/0442; G06N 3/086; G06N 3/092

(52) U.S. Cl. CPC G06N 3/0442; G06N 3/086; G06N 3/092

(57) ABSTRACT

A system and a method are disclosed for performing a neural architecture search. The method includes sampling a discrete network search space a first time, determining a differential architecture network sampled from a super-network using continuous relaxation of the discrete network search space over operators in the super-network, calculating a reward based on a proxy accuracy or a proxy complexity of the differential architecture network, updating a distribution of the discrete network search space based on the reward, and determining an updated differential architecture network based on the reward.

### CROSS-REFERENCE TO RELATED APPLICATION

This application claims the priority benefit under 35 U.S.C. § 119(e) of U.S. Provisional Application No. 63/428,631, filed on Nov. 29, 2022, the disclosure of which is incorporated by reference in its entirety as if fully set forth herein.

### TECHNICAL FIELD

The disclosure generally relates to a framework to merge a reinforcement learning-based neural architecture search (NAS) framework with proxy measurements from differentiable NAS methods to accelerate an architecture searching process.

### SUMMARY

An NAS framework is a system for automating the design of artificial neural networks. It is a type of machine learning that involves using algorithms to search for the best neural network architecture for a specific task. In an NAS framework, an algorithm is used to evaluate different architectures and select the one that performs most efficiently.

Accordingly, NAS may avoid a labor-intensive process of trial and error. Conventional NAS techniques focus on maximizing the prediction performance of the final neural network; however, actual practical models may require consideration of additional criteria, e.g., model size, floating point operations (FLOPs), latency, etc.

To solve this problem reinforcement learning (RL) NAS may be applied to search and provide information over discrete parameters. Unfortunately, RL NAS can take a long time to be performed.

Another potential solution is a differentiable NAS (differentiable architecture search (DARTS), which formulates the architecture search problem using a gradient decent. DARTS can be used to accelerate training of the controller. For example, DARTS introduces the model parameter w and the architecture parameter α, and trains both w and α through a gradient decent-based optimization method to account for additional criteria.

Gradient descent is an optimization algorithm used to find the values of parameters (coefficients and biases) of a function that minimizes a cost function. It is an iterative algorithm, in which a model is trained using the training data, and the parameters are updated iteratively to minimize the error between the predicted output and the true output.

A DARTS super-network advantageously may provide one-shot architecture prediction on architecture topology (e.g., cell design) for a given the search space, which enables fast searching. However, a downside of DARTS is the limitation of determining the size of neural network, including the number of layers, the number of initial channels, and other existing discrete parameters. In addition, the search may be limited to only operators, which limits the number of layers and/or feature maps that can be searched.

To overcome these issues, systems and methods are described herein for providing a framework to design a neural network with multi-objective functions for a given task.

The systems and methods described herein improve on conventional methods because they are able to speed up the NAS process while delivering accurate and consistent results. The solutions proposed by the present application have the potential to significantly improve the performance of machine learning systems.

In an embodiment, a method for performing an NAS includes sampling a discrete network search space a first time, determining a differential architecture network sampled from a super-network using continuous relaxation of the discrete network search space over operators in the super-network, calculating a reward based on a proxy accuracy or a proxy complexity of the differential architecture network, updating a distribution of the discrete network search space based on the reward, and determining an updated differential architecture network based on the reward.

In an embodiment, an electronic device includes at least one processor; and at least one memory operatively connected with the at least one processor, the at least one memory storing instructions, which when executed, instruct the at least one processor to perform a method of performing an NAS by sampling a discrete network search space a first time, determining a differential architecture network sampled from a super-network using continuous relaxation of the discrete network search space over operators in the super-network, calculating a reward based on a proxy accuracy or a proxy complexity of the differential architecture network, updating a distribution of the discrete network search space based on the reward, and determining an updated differential architecture network based on the reward.

### BRIEF DESCRIPTION OF THE DRAWING

In the following section, the aspects of the subject matter disclosed herein will be described with reference to exemplary embodiments illustrated in the figures, in which:

FIG. 1 illustrates a framework for predicting an NAS design space, according to an embodiment;

FIG. 2A illustrates an RL-based LSTM controller used with DARTS, according to an embodiment;

FIG. 2B illustrates an RL-based LSTM controller used with multiple parallel DARTS, according to an embodiment;

FIG. 3 illustrates an outline of an MCTS method, according to an embodiment;

FIG. 4 illustrates an aging evolutionary (AE) controller used with DARTS, according to an embodiment;

FIG. 5 illustrates a flowchart of a method for performing an NAS, according to an embodiment; and

FIG. 6 is a block diagram of an electronic device in a network environment 600, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “counter clock,” “row select,” “pixout,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purposes only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An aspect of the disclosure is to provide a framework to design a neural network with multi-objective functions for a given specific task.

The framework, according to an embodiment of the disclosure, predicts a design space for an NAS algorithm to identify high-performing network topology. The NAS design space may define a range of architectures that the algorithm is allowed to consider. The framework may consist of three parts:
1. leveraging controller models to predict the search space,
2. quickly estimating proxy rewards by leveraging the existing NAS techniques (e.g. DARTS), and
3. updating the controller using a policy gradient with proxy rewards. The proxy rewards may include prediction performance, FLOPs, model size, latency, etc.

In accordance with an embodiment of the disclosure, a search space design is provided for a differentiable NAS framework which can include two components:
1. an algorithm to sample a search space, and
2. a proxy measure from the architecture to update the algorithm.

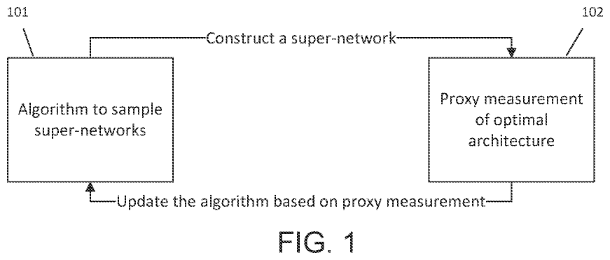

FIG. 1 illustrates a framework for predicting an NAS design space, according to an embodiment.

Referring to FIG. 1, an algorithm to sample super-networks is provided at reference numeral 101 to define a search space, and a proxy measure of optimal architecture is provided at reference numeral 102.

A super-network, in the context of machine learning, is a neural network that is composed of multiple subnetworks or “experts” that each specialize in different tasks or regions of the input space. The experts are combined in a way that allows the super-network to make more accurate predictions than any of the individual experts alone.

One way to create a super-network is to use a combination of subnetworks that have been trained independently, either on different tasks or on the same task using different training data. Another approach is to train the experts jointly, with the super-network learning to route input examples to the most appropriate expert based on some learned criteria. Super-networks can be useful in situations where the input data has multiple different features or characteristics that are best handled by different types of models. A super-network may be a tool to find an optimal architectural topology to achieve improved performance. In this sense, the super-network may be used to identify whether or not a given subnetwork candidate has an optimal topology.

A super-network may be composed of multiple alternate computation paths emerging from each of its feature nodes, wherein a subset of its paths and nodes can be sampled to form a sub-network. The sampled sub-network may have a smaller number of feature nodes than the super-network it is sampled from, resulting in a smaller number of layers or a smaller number of feature channels at each layer. The sampled sub-network may also have a smaller number of computation paths than the super-network it is sampled from, corresponding to a smaller number of computational kernels or compute operators.

After the super-networks are sampled by the algorithm at reference numeral 101, the proxy measure of optimal architecture may be provided at reference numeral 102, which in turn, may be used to update the algorithm based on the proxy measure. For example, the super-networks may be sampled by the algorithm at reference numeral 101 using reinforcement learning (RL)-based long short-term memory (LSTM) blocks and/or a Monte-Carlo tree search (MCTS) method. Accordingly, using RL-LSTM blocks and/or the MCTS method the proxy measure of an optimal architecture can be collected from a differentiable NAS method or its variants at reference numeral 102. The RL-LSTM blocks and RL-MCTS method will be explained in further detail below.

RL is a type of machine learning in which an agent learns to interact with its environment in order to maximize a reward signal. In the context of NAS, RL can be used as a technique to optimize the design of a neural network. In this case, the agent may be an NAS algorithm, and the environment may be a set of possible neural network architectures. The reward signal may be the performance of the neural network for a specific task (e.g., image classification or language translation).

The NAS algorithm may use RL to interact with the environment by evaluating different neural network architectures and selecting one or more architectures that perform best. The algorithm may learn over time which architectures are most effective, and continually update its selection strategy based on learned past experiences.

By using RL as part of NAS architecture, it is possible to automate the design of neural networks and achieve better performance on a wide range of tasks.

In addition, DARTS may be used to automate the design of artificial neural networks using a gradient-based optimization. This may include using a differentiable function to represent the space of possible neural network architectures, and then using gradient descent to search for the optimal architecture.

For example, in a DARTS system, the differentiable function maps the parameters of a neural network architecture to a scalar value, which represents the performance of the architecture on a specific task. The parameters of the architecture are optimized using gradient descent, which involves calculating the gradient of the function with respect to the parameters and updating the parameters in the direction that reduces the function value.

DARTS is a method that leverages continuous relaxation of a discrete network search space to search the topology of a normal cell and reduction cell to construct a full network.

Continuous relaxation of a discrete network search space may refer to the process of approximating a discrete optimization problem with a continuous one. This can be done by replacing discrete variables with continuous ones and adding constraints to ensure that the solution stays within the space of valid discrete solutions. A continuously relaxed problem can then be solved using techniques from continuous optimization, and the solution can be rounded back to the nearest valid discrete solution.

DARTS defines a cell to be a directed acyclic graph (DAG) including N nodes, where the node x⁽ⁱ⁾ represents a latent representation (e.g., a feature map of a convolutional neural network). Each edge may be represented by i and j, respectively, and may be associated with an operation o^{(i,j)} that transforms x⁽ⁱ⁾. Each edge i and j may correspond to candidate operations (e.g., convolution, max pooling, or zero padding)_transferring a transformed representation on a node prior to the next node. Each intermediate node may be defined based on all the predecessor nodes according to Equation (1), below:

$${x}^{( j )} = {\sum }_{i < j} {o}^{( i , j )} ( {x}^{( i )} ) \qquad ( 1 )$$

Accordingly, the continuous relaxations from node i to j may be the convex combinations of representations of all possible operations as shown in Equation (2), below:

$${\overline{o}}^{( i , j )} ( x ) = {\sum }_{o ∈ O} \frac{exp {α}_{o}^{( i , j )}}{{\sum }_{{o}^{′} ∈ O} exp {α}_{{o}^{i}}^{( i , j )}} o ( x ) \qquad ( 2 )$$

where O is a set of candidate operations and αₒ is a parameter learnable by the network search algorithm to assign priority to operator o.

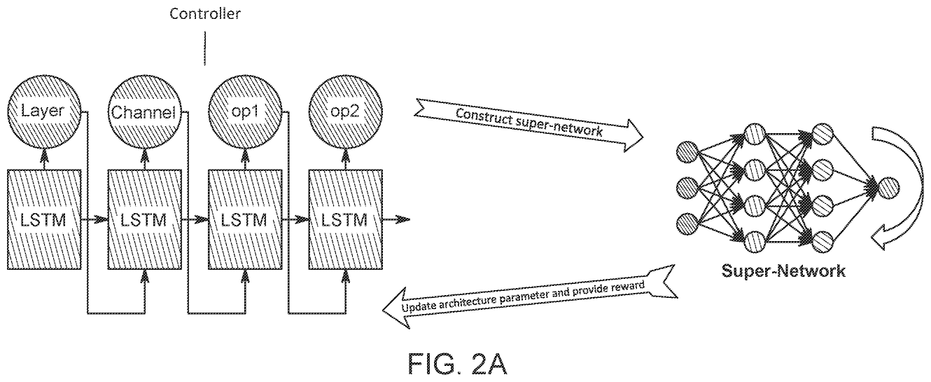

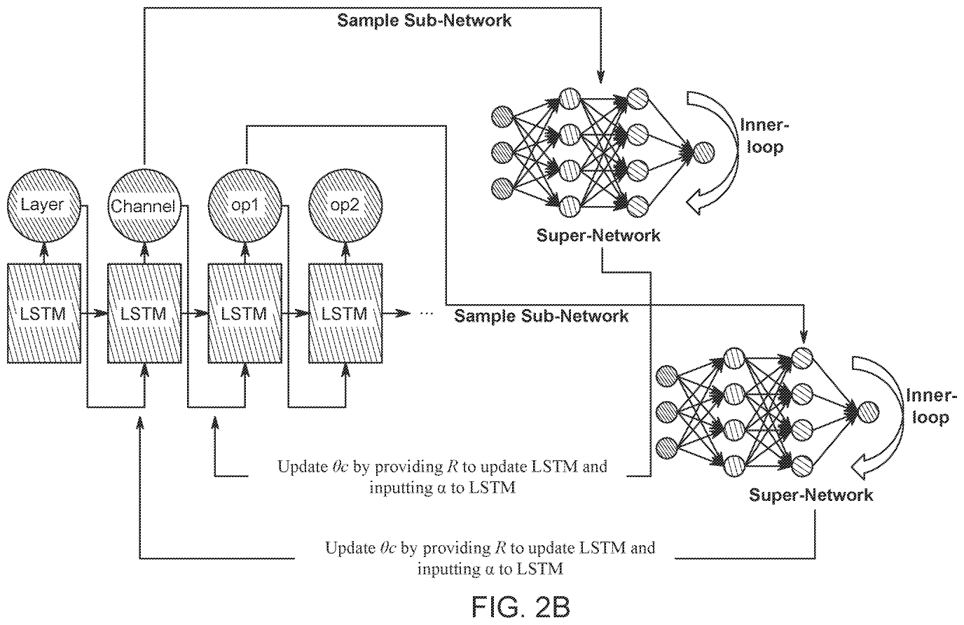

FIG. 2A illustrates an RL-based LSTM controller used with DARTS, according to an embodiment.

Referring to FIG. 2A, an RL-based LSTM controller is connected to a subnetwork.

LSTM is a type of recurrent neural network (RNN) that is capable of learning long-term dependencies in data. RNNs are a type of neural network that process sequential data, such as time series or natural language, by updating a hidden state at each time step based on both the current input and the previous hidden state. This allows RNNs to capture temporal relationships and dependencies in the data.

LSTM is able to retain information for long periods of time, making it useful for tasks that require a model to remember past events. RL-based LSTM is a combination of these two techniques, in which an LSTM network is used to learn a policy for an RL agent. This can be used to allow the agent to make decisions based on long-term dependencies and patterns in the data.

The RL-based LSTM NAS provided by FIG. 2A may provide fast proxy rewards using DARTS methods. RL samples a subnetwork by determining the discrete components as layers and number of channels, input/output feature maps, then provides this to DARTS to search for one or more operators in a fast manner (e.g., using continuous relaxation). A loss function (e.g., a loss function based on cross entropy, size of the network, complexity of the parameter) of the super-network may be used as a reward function to update the controller. In addition, an architecture parameter including parameters of an encoded subnetwork may be used as an input to the controller.

FIG. 2B illustrates an RL-based LSTM controller used with multiple parallel DARTS, according to an embodiment.

Referring to FIG. 2B, an RL-based LSTM controller is connected to multiple subnetworks. RL may sample the subnetworks to determine the discrete components and then provide this to multiple parallel DARTS requests at the same time, e.g. for the top two or more probable architectures.

Referring to FIGS. 2A-2B, the one or more LSTM controllers sample a super-network by defining a search space. Trained super-networks provide a reward R to update the one or more LSTM controllers. Also, the architecture parameter α becomes the input to the LSTM controller.

In an RL-based LSTM controller NAS framework, the controller parameterized by θc predicts a neural network topology and leverages the sampled neural network's prediction performance to update θc via gradient ascent. The controller may be a sequential LSTM block predicting a list of action a_{1:T}, encoded information to construct the neural network.

If R is the reward signal from the sampled neural network consisting of prediction performance, model size, and latency, then the controller reward should be maximized and is defined in Equation (3), below.

J(θ_{c})=E_{P(a}_{_{1:T}}_{;θ}_{_{c}}₎[R] (3)

Due to the non-differentiable property on the reward signal R, the controller can iteratively be updated through the policy gradient defined in Equation (4), below.

$${∇}_{{θ}_{c}} J ( {θ}_{c} ) \approx \frac{1}{m} {\sum }_{k = 1}^{m} {\sum }_{t = 1}^{T} {∇}_{{θ}_{c}} log P ( {a}_{t} \vert {a}_{( t - 1 ) : 1} ; {θ}_{c} ) {R}_{k} \qquad ( 4 )$$

where m is the number of sampled architectures for Monte-Carlo approximation on a policy gradient. Calculating the policy gradient may be achieved by calculating the reward signal R, which requires the training process of sampled architecture until a convergence, which may take a significant amount of time.

DARTS may be used to accelerate the LSTM controller training.

According to an embodiment of the disclosure, a super-network from DARTS may be leveraged as a proxy to evaluate the reward of updating the controller. For example, a DARTS super-network may search the cells' topology and return a proxy accuracy to the final cells' topology. Then, at least one RL controller updates its weights through policy gradient and samples the new super-network by predicting, one or more of: 1) the number of layers, 2) the number of initial channels, 3) operations space, 4) use of reduction cells, and 5) any other discrete parameters.

Given the architecture parameter α from the fully trained super-network, an accurate reward can be measured through the additional training on final architecture based on α by retaining the strongest operations for each node i to node j based on the following scores shown in Equation (5), below.

$${score}_{( i , j )} = \frac{exp ( {α}_{o}^{( i , j )} )}{{\sum }_{{o}^{′} ∈ O} exp ( {α}_{{o}^{′}}^{( i , j )} )} \qquad ( 5 )$$

An LSTM controller block applies the architecture parameter α found from DARTS to improve prediction of the original LSTM controller block. The original LSTM controller block may use a randomly initialized input (or a fixed input) to start autoregressive predictions of NAS architecture components.

DARTS variants, such as partial channel (PC)-DARTS, gradient-based searching approach using differentiable architecture sampling (GDAS), β-DARTS, and DARTS with adaptive sharpness minimization (DARTS-ASAM) can also be used.

The reward signal R may be based on the following criteria:
1. Test accuracy of a super-network.
2. Latency/FLOP of found architecture: this can be measured by an inference from an untrained network built with found cells.
3. Model size of found architecture: this can be measured by counting the number of parameters from untrained network built from found cells.
4. Search time of super-network: actual training time of the super-network.

The reward signal R can be written based on Equation (6), below.

R=ACC(m)^{α}·LAT(m)^{β}·MODELSIZE (m)^{γ}·SEARCHTIME (m)^{δ}.estimated_area(m)^{ϵ} (6)

where α, β, γ, δ, ϵ ∈R, m ∈ A, and A is a set of architecture candidates.

According to another embodiment, LSTM controllers may be replaced with an MCTS. This is a variation of RL-based NAS with a differentiable NAS method by replacing the LSTM controller with an MCTS method. In this manner, MCTS may be used to identify discrete parameters (e.g., the first two levels of the tree, which may correspond to layers and channels per layer).

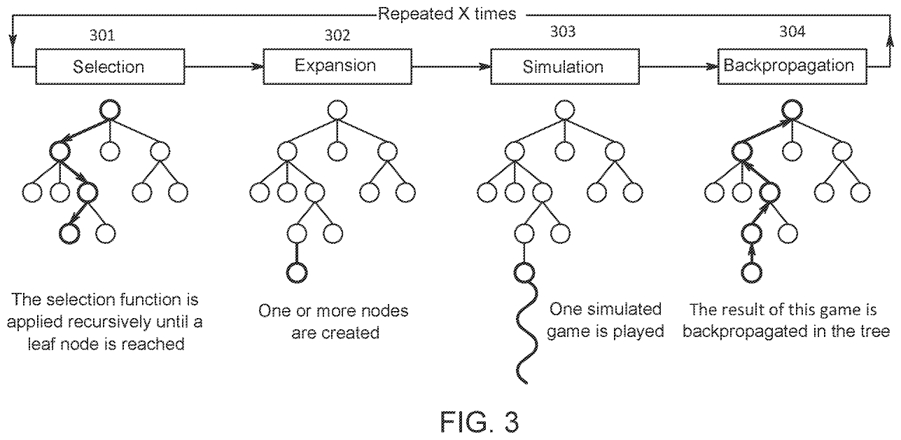

FIG. 3 illustrates an outline of an MCTS method, according to an embodiment.

MCTS is a method to find the optimal decision based on two concepts. First, the value of the action (typically corresponding to the leaf node) can be estimated through a stochastic process. Second, these values can be used to efficiently control an exploration-exploitation problem. Accordingly, MCTS may be used to approximate the value of the node, and use the upper confidence bound for trees (UCT) to determine which node should be selected. The selection of the node j may be based on the UCT shown below in Equation (7):

$$UCT = \overline{{X}_{j}} + 2 {C}_{p} \sqrt{\frac{2 ln n}{{n}_{j}}} \qquad ( 7 )$$

where n is the number of times a parent has been visited, nⱼ is the number of times the node j has been visited, X̅ⱼ is an empirical mean of rewards at the node j, and Cp is an exploration constant, which is a hyperparameter to control the exploration-exploitation in RL setup.

Referring to FIG. 3, at block 301, the selection function is applied recursively until a leaf node is reached. At block 302, one or more nodes are created. At block 303, a simulated game is played. At block 304, the result of the game is backpropagated in the tree. Steps 301-304 may be repeated to improve a sampling accuracy of the discrete network search space.

The tree may predict the architecture components in the sequence of layers, channels, and operations.

According to another embodiment, LSTM controllers may be replaced with an AE local search algorithm. This is a variation of RL-based NAS with a differentiable NAS method by replacing the LSTM controller with an AE local search algorithm. In this manner, AE may be used to identify discrete parameters (e.g., the first two levels of the tree, which may correspond to layers and channels per layer).

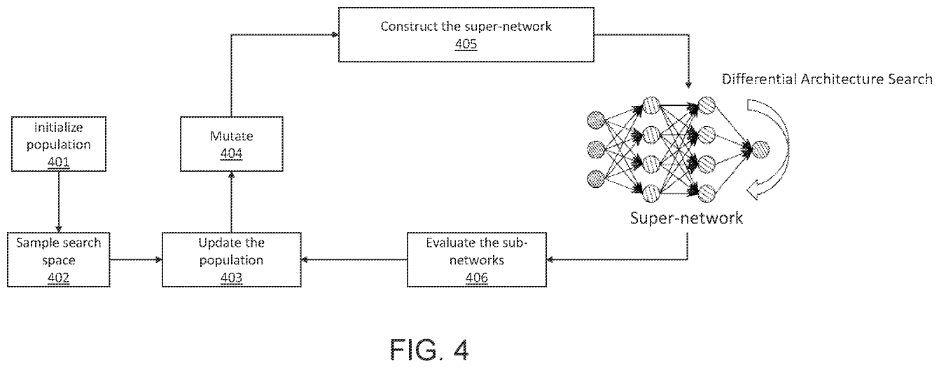

FIG. 4 illustrates an AE controller used with DARTS, according to an embodiment.

Referring to FIG. 4, a local search routine called AE controller is used with DARTS, as illustrated in FIG. 4. The AE controller maintains a population of P architectures whose discrete parameters are selected from a search space. The population represents a group of candidate solutions or architectures that are being evolved and searched over time.

At the start of the routine, a population of P architectures is initialized at block 401. The search space, which represents a range of possible candidate solutions, is sampled at block 402. The population is then updated at block 403 based on inputs from the sample search space at block 402 and evaluation of the sub-networks at block 406. A predetermined number of search spaces is set to determine the population size, and a rule may be implemented to update the population by discarding the lowest ranked search space until the predetermined number is reached.

In each search round, S architectures are subsampled, and the one that gives the largest reward is chosen. The winning architecture is mutated at block 404, and an offspring is produced by performing a random morphism. The reward is determined based on a parameter (e.g., loss) of the super-network, which is evaluated at block 406. The population is updated by adding the offspring architecture and replacing the oldest architecture.

The AE-DARTS algorithm is applied by constructing a super-network based on the search space(s) in the population at block 405. DARTS is then applied on the offspring architecture to quickly find the optimal operations of the architecture. The resulting architecture is added to the population, and AE may be applied again on the updated population. Alternatively, DARTS may be applied on multiple offspring architectures in parallel to replace the oldest offspring in the population. Sub-networks of the super network may be generated based on α and evaluated at block 406 by retraining or estimating the sub-networks to return a parameter (e.g., loss) to rank the search spaces in the population.

As mentioned above, DARTS variants, such as DARTS-ASAM, may be used

While DARTS may accelerate the search time to find a good candidate cell topology, DARTS may not find the best architecture. For example, DARTS may be encumbered by an overfitting problem on architecture parameter α, leading to a bad performance.

DARTS-ASAM may be categorized as a variant of DARTS, which also can be the candidate to proxy the performance from the super-network. DARTS-ASAM may modify the bi-level objective functions from DARTS, enforcing the flatter minima in both network parameter w and architecture parameter α based on Equation (8), below:

$${min}_{α} {max}_{{‖ δ ‖}_{p} \leq ρ} {L}_{val} ( {w}^{*} ( α ) , α + δ ) \qquad ( 8 )$$

$$s . t . {w}^{*} ( α ) = {arg min}_{w} {max}_{{‖ ϵ ‖}_{p} \leq δ} {L}_{train} ( α , w + ϵ )$$

The ASAM algorithm may be applied to solve a bi-level objective function. The ASAM algorithm may be an objective function to cause a flatter output for the gradient descent-based optimization (e.g., in both network parameter w and architecture parameter α). The ASAM algorithm may be described as follows:

### DARTS-ASAM Pseudo Algorithm:

1. Create a mixed operation ō^{(i,j)} parameterized by α^{(i,j)} for each edge (i, j).
2. While not converged:
   i. Update architecture α by descending ∇_{α}Lᵥₐₗ(w, α)|_{α+\hat{ϵ} (α)}.
   ii. Update weights w by descending ∇_{w}Lₜᵣₐᵢₙ(w, α)|_{w+\hat{ϵ}(w)}.
3. Derive the final architecture based on the learned α.

Accordingly, the abovementioned pseudo algorithm may be presented according to Equations (9)-(11), below.

$$\hat{ϵ} ( w ) = δ \frac{sign ( {∇}_{w} {L}_{train} ( w ) ) {\vert {∇}_{w} {L}_{train} ( w ) \vert}^{q - 1}}{{( {‖ {∇}_{w} {L}_{train} ( w ) ‖}_{q}^{q} )}^{\frac{1}{p}}} \qquad ( 9 )$$

$$\hat{ϵ} ( α ) = ρ \frac{sign ( {∇}_{α} {L}_{val} ( α ) ) {\vert {∇}_{α} {L}_{val} ( α ) \vert}^{q - 1}}{{( {‖ {∇}_{α} {L}_{val} ( α ) ‖}_{q}^{q} )}^{\frac{1}{p}}} \qquad ( 10 )$$

$$\frac{1}{p} + \frac{1}{q} = 1 \qquad ( 11 )$$

According to another embodiment, a neural tangent kernel (NTK) as a proxy reward may be used.

An NTK may represent a relationship between the input and output of a neural network and include information regarding a networks' characteristics.

In the context of RL, the NTK can be used as a proxy reward, which means that it can be used as an approximation of the true reward that the agent is trying to maximize. This can be useful in situations where the true reward is difficult to measure or evaluate, or where it is computationally infeasible to compute the true reward for every possible action that the agent could take. By using the NTK as a proxy reward, the agent can learn to perform tasks without having to explicitly compute the true reward at each step.

For example, let f: [symbol] ^{M}→ [symbol] be a function parameterized by θ ∈ [symbol] ^{P} and x₁, x₂ ∈ [symbol] ^{M} be two inputs to the network. Then, the NTK matrix Θ_{θ}^{T} may be computed based on Equation (12), below:

$${Θ}_{θ}^{f} ( {x}_{1} , {x}_{2} ) = {[ \frac{\partial f ( θ , {x}_{1} )}{\partial θ} ] [ \frac{\partial f ( θ , {x}_{2} )}{\partial θ} ]}^{T} \qquad ( 12 )$$

In an infinite-width regime, the NTK matrix may be a constant function of the weight θ, which enables the explanation on training dynamic, and generalization. The complexity of calculating the NTK matrix for finite width networks may be for a given batch size N, the memory and time complexity are O(NP) and O(N²P), respectively.

The information from an NTK matrix of a given architecture (e.g., a negation of a condition number or a Frobenius norm (e.g., a type of matrix norm that is defined as the square root of the sum of the squares of the absolute values of the elements of the matrix)) may be leveraged as a proxy for the accuracy for the RL-based NAS method.

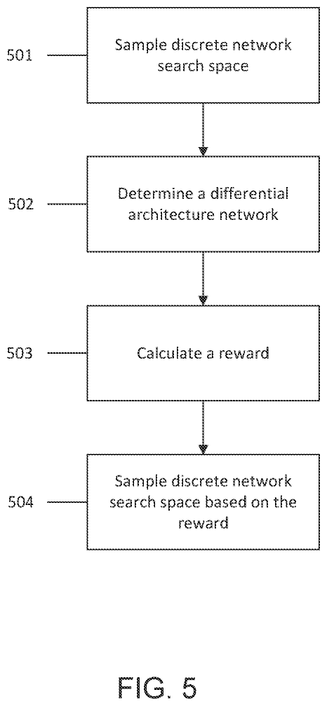

FIG. 5 illustrates a flowchart of a method for performing an NAS, according to an embodiment. The steps shown in FIG. 5 may be performed by a controller (e.g., a processor) of an electronic device.

Referring to FIG. 5, in step 501, a discrete network search space is sampled. At this point the discrete network search space is sampled a first time. RL may be used to sample the discrete network search space.

In step 502, a differential network architecture is determined. The differential architecture network may be sampled from a super-network using continuous relation of the discrete network search space over operators in the super-network.

In step 503, a reward is calculated. The reward may be calculated based on a proxy accuracy or a proxy complexity of the differential architecture network.

In step 504, the discrete network search space is sampled based on the reward. That is, the discrete network search space may be sampled a second time using RL based on the reward to improve a sampling accuracy of the discrete network search space.

Even though the discrete network search space described above is said to be sampled a “first time” and a “second time”, these expressions are not limiting. For example, the “first time” may simply refer to any timepoint that occurs prior to a “second time”.

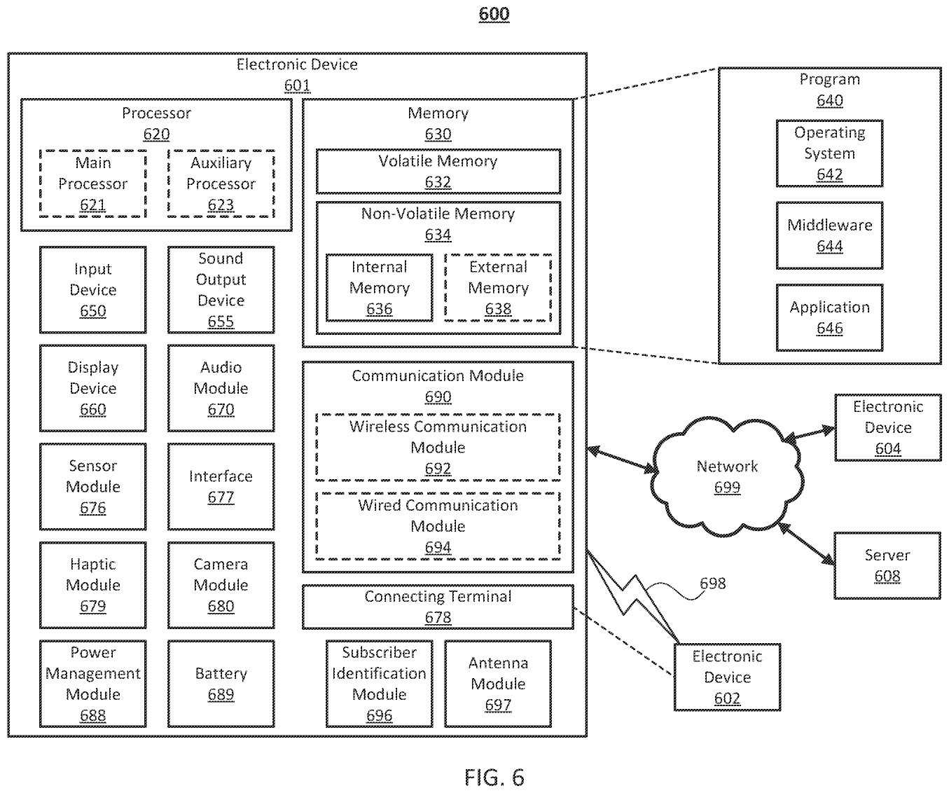

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 640, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 694. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 646 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as Bluetooth™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for performing a neural architecture search, comprising:
sampling a discrete network search space a first time,
determining a differential architecture network sampled from a super-network using continuous relaxation of the discrete network search space over operators in the super-network,
calculating a reward based on a proxy accuracy or a proxy complexity of the differential architecture network,
updating a distribution of the discrete network search space based on the reward, and
determining an updated differential architecture network based on the reward.

2. The method of claim 1, further comprising:
sampling the discrete network search space a second time based on the reward to improve a sampling accuracy of the discrete network search space.

3. The method of claim 2, wherein sampling the discrete network search space the first or second time includes determining discrete components comprising at least one of a layer, a number of channels, and an input or output feature map.

4. The method of claim 3, further comprising:
performing a differentiable neural architecture search (DARTS) based on the determined discrete components.

5. The method of claim 3, further comprising:
simultaneously performing multiple differentiable neural architecture searches (DARTSs) in parallel based on the determined discrete components.

6. The method of claim 1, wherein at least one non-differentiable measurement is combined with the reward and comprises at least one of a floating point operations (FLOPs) complexity, an area per pixel, a chip area, or an indication of memory consumption.

7. The method of claim 1, wherein the discrete network search space is sampled by predicting one or more of a number of layers, a number of initial channels, an operations space, or a use of reduction cells.

8. The method of claim 1, wherein the discrete network search space is sampled based on a Monte-Carlo tree search function.

9. The method of claim 1, wherein the discrete network search space is sampled based on an aging evolutionary (AE) search function.

10. The method of claim 1, wherein the discrete network search space is sampled based on reinforcement learning (RL).

11. An electronic device, comprising:
at least one processor; and
at least one memory operatively connected with the at least one processor, the at least one memory storing instructions, which when executed, instruct the at least one processor to perform a method of performing a neural architecture search by:
sampling a discrete network search space a first time,
determining a differential architecture network sampled from a super-network using continuous relaxation of the discrete network search space over operators in the super-network,
calculating a reward based on a proxy accuracy or a proxy complexity of the differential architecture network,
updating a distribution of the discrete network search space based on the reward, and
determining an updated differential architecture network based on the reward.

12. The electronic device of claim 11, wherein the processor is further instructed to:
sample the discrete network search space a second time based on the reward to improve a sampling accuracy of the discrete network search space.

13. The electronic device of claim 12, wherein sampling the discrete network search space the first or second time includes determining discrete components comprising at least one of a layer, a number of channels, and an input or output feature map.

14. The electronic device of claim 13, wherein the processor is further instructed to:
perform a differentiable neural architecture search (DARTS) based on the determined discrete components.

15. The electronic device of claim 13, wherein the processor is further instructed to:
simultaneously perform multiple differentiable neural architecture searches (DARTSs) in parallel based on the determined discrete components.

16. The electronic device of claim 11, wherein at least one non-differentiable measurement is combined with the reward and comprises at least one of a floating point operations (FLOPs) complexity, an area per pixel, a chip area, or an indication of memory consumption.

17. The electronic device of claim 11, wherein the discrete network search space is sampled by predicting one or more of a number of layers, a number of initial channels, an operations space, or a use of reduction cells.

18. The electronic device of claim 11, wherein the discrete network search space is sampled based on a Monte-Carlo tree search function.

19. The electronic device of claim 11, wherein the discrete network search space is sampled based on an aging evolutionary (AE) search function.

20. The electronic device of claim 11, wherein the discrete network search space is sampled based on reinforcement learning (RL).
